(19) United States
(12) Patent Application Publication
(10) Pub. No.: US 2013/0086300 A1
(43) Pub. Date: Apr. 4, 2013

(54) STORAGE CACHING ACCELERATION THROUGH USAGE OF R5 PROTECTED FAST TIER

(71) Applicant: Bert Luca, Cumming, GA (US)

(72) Inventor: Bert Luca, Cumming, GA (US)

(73) Assignee: LSI CORPORATION, Milpitas, CA (US)

(21) Appl. No.: 13/252,553

(22) Filed: Oct. 4, 2011

(51) Int. Cl. G06F 12/02

(52) U.S. Cl. 711/102; 711/E12.008

(57) ABSTRACT

A data storage system with redundant SSD cache includes an SSD cache organized into logical stripes, each logical stripe having several logical blocks. The logical blocks of each stripe are organized into logical data blocks and one logical parity block. Data may be written to the SSD cache by performing an exclusive disjunction operation on the logical parity block, the new data and the existing data in logical stripe to update the parity block, then writing the new data over the existing data in a logical data block in the same logical stripe.

### FIELD OF THE INVENTION

The present invention is directed generally toward data storage systems and more particularly toward a method for implementing redundancy in tiered memory.

### BACKGROUND OF THE INVENTION

Data storage technology focuses on providing the greatest capacity and availability, with the greatest performance, at a minimum cost. RAID technology increased the capacity of data storage systems for minimal cost by combining multiple independent, inexpensive hard disks into a large array. Later RAID technology increased availability by adding fault tolerance at the expense of capacity and performance.

State of the art data storage systems are beginning to incorporate solid state drive (SSD) technology. SSD are arrays of semiconductor memory elements, so every memory element is accessible with electrical signals as opposed to a hard drive which relies on mechanically spinning disks and mechanically actuated arms. SSDs are orders of magnitude faster than hard drives. SSDs are also more expensive than hard drives per unit of data storage.

Some data storage technologies have attempted to combine the performance of SSD with the high capacity per unit cost of hard drives by incorporating SSDs as tiers or caches. SSD caches provide increased performance for any operation that can access the SSD cache instead of a hard drive. Because the access time of a hard drive may be orders of magnitude larger than the access time of SSDs, the performance of a data storage system using an SSD cache is directly related to the percentage of time the system can access the SSD cache instead of the hard drive (the “hit rate”). The hit rate is generally governed by the capacity of the SSD cache.

SSD cache capacity may simply be the physical capacity of the SSD device; however, SSD memory can suffer discreet failures; consequently it would be advantageous if a method and apparatus existed that were suitable for providing redundancy to SSD cache memory while preserving SSD cache capacity.

### SUMMARY OF THE INVENTION

Accordingly, the present invention is directed to a novel method and apparatus for providing redundancy to SSD cache memory while preserving SSD cache capacity.

One embodiment of the present invention includes a data storage system having a process, memory, SSD cache and hard drive. The SSD cache includes internal, logical blocks organized into stripes, where the logical blocks provide RAID 5 type parity redundancy for each other.

Another embodiment of the present invention includes a method for providing RAID 5 like redundancy for a plurality of logical blocks in an SSD cache. The method includes writing data to a logical block in a stripe of an SSD cache, performing a logical exclusive disjunction (XOR) operation on all of the logical blocks in the stripe except for one parity block, and writing the result of the XOR operation to the parity block.

Devices and methods according to the present invention provide redundancy while preserving SSD cache capacity. SSD cache capacity is preserved by using RAID 5, or parity type redundancy, as opposed to RAID 1, or mirroring type redundancy.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles.

### BRIEF DESCRIPTION OF THE DRAWINGS

The numerous objects and advantages of the present invention may be better understood by those skilled in the art by reference to the accompanying figures in which:

FIG. 1 shows a block diagram of a device for implementing at least one embodiment of the present invention;

FIG. 2 shows a block diagram of an SSD cache organized into stripes according to the present invention;

FIG. 3 shows a flowchart of a method for writing data to an SSD cache organized into stripes for redundant storage according to the present invention; and

FIG. 4 shows a flowchart for recovering data from an SSD cache organized into stripes for redundant storage according to the present invention.

### DETAILED DESCRIPTION OF THE INVENTION

Reference will now be made in detail to the subject matter disclosed, which is illustrated in the accompanying drawings. The scope of the invention is limited only by the claims; numerous alternatives, modifications and equivalents are encompassed. For the purpose of clarity, technical material that is known in the technical fields related to the embodiments has not been described in detail to avoid unnecessarily obscuring the description.

One implementation of a data storage system using SSD and hard drives is a hard drive with an SSD cache. Read operations performed on such a system have performance that is roughly inversely proportional to the hit rate of the cache. The hit rate is the percentage of read operations that find the requested data in the cache. Because read operations take orders of magnitude longer to perform on a hard drive than an SSD, the amount of time spent performing read operations can be estimated as the amount of time the hard drive spends performing a read operation multiplied by the inverse of the hit rate. Therefore, performance of the data storage system can be improved by increasing the hit rate. The hit rate of an SSD cache is governed by the capacity of the SSD cache. The capacity of the SSD cache is the amount of the SSD memory available for storing cached data. Where an SSD cache does not use any type of redundancy, the capacity is the entire SSD memory.

However, SSD memory is subject to failures resulting in corrupted data. Where data in a cache is corrupted, the data storage system may have to read the corresponding data from the hard drive, effectively lowering the hit rate even though the data was stored in the SSD cache. Data corruption in a cache may also result in data loss where data becomes corrupted after it is written to a cache but before it is written to a hard drive. Therefore, some type of redundancy may be desirable in an SSD cache. Various types of redundant data storage are available. One type of redundant data storage, embodied in RAID 1, involves maintaining two copies of all data (mirroring). An SSD cache utilizing mirroring will only have about half of the SSD memory available for caching because all data written to the SSD cache must be written twice. The present invention is directed toward using parity type redundancy in SSD caches. Parity type redundancy, such as embodied in RAID 5, is more efficient in terms of capacity usage than mirroring because parity type redundancy allows one segment of an SSD cache to serve as a redundant backup for multiple, similarly sized segments of data. Parity type redundancy therefore increases the overall capacity of a redundant SSD cache, thereby allowing for a higher hit rate as compared to an SSD cache with mirroring type redundancy.

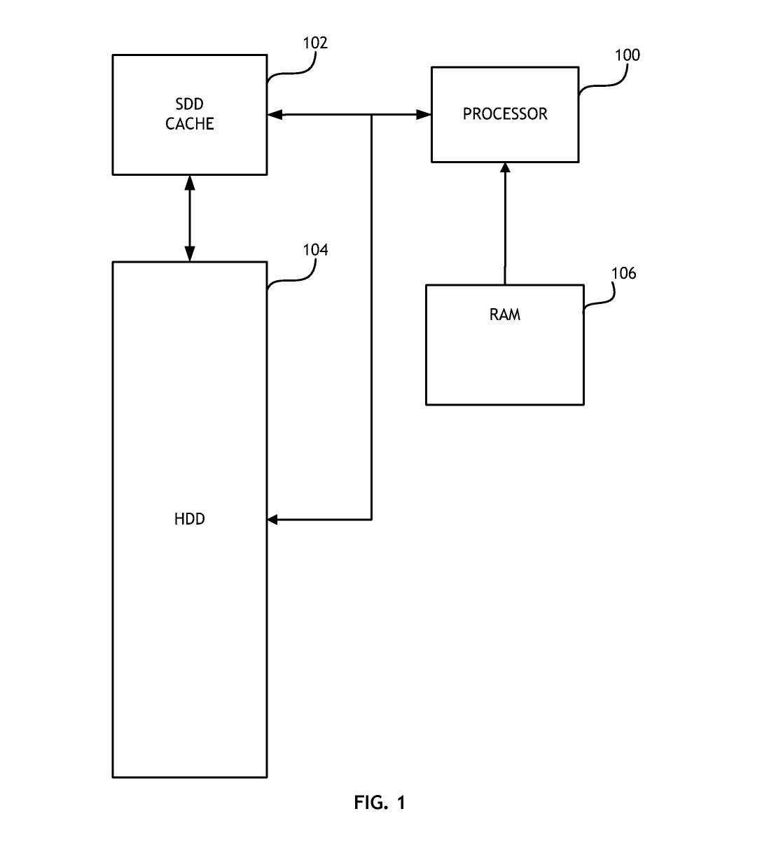

Referring to FIG. 1, a data storage system according to the present invention may include a processor 100 connected to a memory 106, a hard drive 104 and an SSD cache 102 also connected to the processor 100. The SSD cache 102 may be a cache for the hard drive 104.

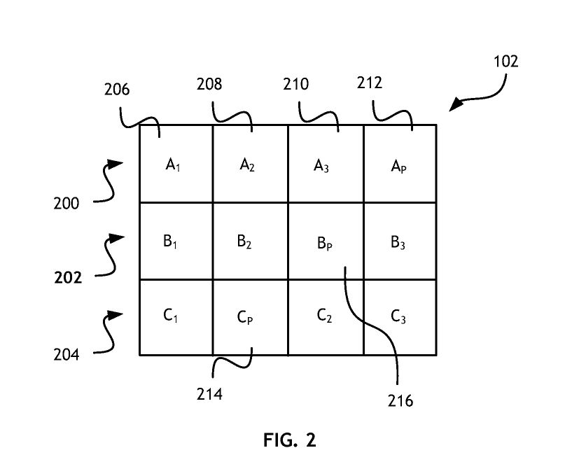

Referring to FIG. 2, an SSD cache 102 may be organized into logical stripes 200, 202 and 204. Each logical stripe 200, 202 and 204 may contain a plurality of equally sized logical blocks; for example a first logical stripe 200 may include a first logical data block A₁ 206, a logical second data block A₂ 208, a third logical data block A₃ 210 and a logical parity block 212 Aₚ. Each logical block 206, 208, 210 and 212 may be a logical division of the first logical stripe 200. The logical data blocks 206, 108 and 210 may contain data while the logical parity block 212 may contain the results of an exclusive disjunction operation performed on all of the logical data blocks 206, 208 and 210 in the logical first stripe 200. Each of the other logical stripes 202 and 204 may be similarly organized. It will be appreciated that while FIG. 2 shows an SSD cache 102 having three logical stripes 200, 202 and 204, in practice an SSD cache 102 may have more or fewer logical stripes. Likewise, while FIG. 2 shows each logical stripe 200, 202 and 204 divided into three logical data blocks and one logical parity block, in practice logical stripes in an SSD cache 102 may be divided into any number of logical data blocks greater than one and one logical parity block. Parity type redundancy allows a higher percentage of the total capacity of the SSD memory to be available for use as a cache, as compared to other types of redundancy, because one logical parity block provides redundancy for numerous equally sized logical data blocks.

FIG. 2 illustrates an SSD cache 102 having a RAID 5 type distributed parity structure. In a traditional RAID 5 system, multiple hard drives are divided into stripes such that each stripe contains one block from each hard drive. One block in each stripe is a parity block containing data from an exclusive disjunction operation performed on the other blocks in the stripe. Parity blocks may be staggered such that no hard drive contains all of the parity blocks.

Similarly, an SSD cache 102 may be logically organized such that no logical parity block 212, 214 and 216 coincides with any other logical parity block 212, 214 and 216 in any logical division of the SSD cache 102.

Referring to FIG. 1 and FIG. 2, a data storage system implementing the present invention with an SSD cache 102 organized with a RAID 5 type structure may create a logical parity block by performing an exclusive disjunction operation on all of the logical data blocks in a logical stripe. For example, the processor 100 may perform an exclusive disjunction operation on logical data blocks A₁ 206, A₂ 208 and A₃ 210 in a first logical stripe 200 to produce parity information. The processor may then write the parity information to a logical parity block Aₚ 212 in the first logical stripe 200. The data storage system may also add data to the SSD cache 102 by executing a write operation to a logical block in a logical stripe in the SSD cache 102. For example, the processor 100 may update logical parity block Aₚ 212 by performing an exclusive disjunction operation on the logical parity block Aₚ 212, the existing data-to-be-overwritten, such as logical data block A₁ 206 and the new data. The processor 100 may then write the new data to logical data block A₁ 206.

When data in the SSD cache 102 is corrupted, the processor 100 may recover the corrupted data by performing operations on the other logical blocks in the logical stripe containing the corrupted data rather than reading the data from the hard drive. If a logical parity block is corrupted, parity information may be recalculated from the logical data blocks in the logical stripe. For example, where logical parity block Aₚ 212 is corrupted, the processor 100 may perform an exclusive disjunction operation on logical data blocks A₁ 206, A₂ 208 and A₃ 210 in the first logical stripe 200 to produce parity information. The processor may then overwrite the parity information to a logical parity block Aₚ 212 in the first logical stripe 200. Where data in a logical data block is corrupted, the corrupted logical data block may be recovered from the remaining logical data blocks and the logical parity block. For example, where logical data block A₁ 206 is corrupted, the processor 100 may perform an exclusive disjunction operation on logical data blocks A₂ 208 and A₃ 210, and logical parity block Aₚ 212 to recover the data in logical data block A₁ 206. The processor 100 may then write the recovered data to logical data block A₁ 206 if logical data block A₁ 206 is physically capable of storing data.

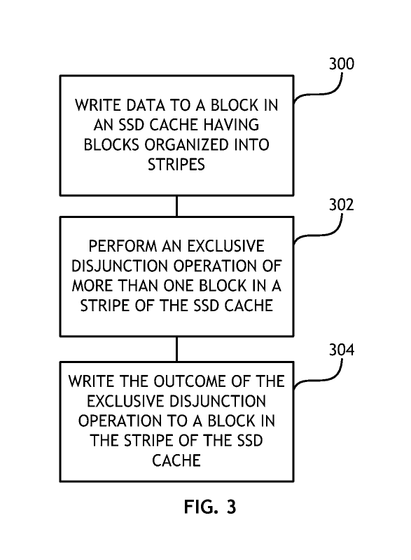

Referring to FIG. 3, another embodiment of the present invention is a method for writing data to an SSD cache organized with parity type redundancy. The method may include writing 300 data to a logical block in a logical stripe of an SSD cache, where the SSD cache is divided into logical stripes having equally sized logical blocks. Where parity information for the logical stripe already exists, the parity information can be updated by performing 302 an exclusive disjunction operation on the newly written data, the existing logical data block that will be overwritten, and the existing logical parity block. New parity information may then be written 304 to the existing logical parity block, replacing the existing parity information. Where parity information for the logical stripe does not already exist, new parity information may be generated by performing 302 an exclusive disjunction operation on all of the logical data blocks in the logical stripe. The newly generated parity information may then be written 304 to a logical parity block in the logical stripe.

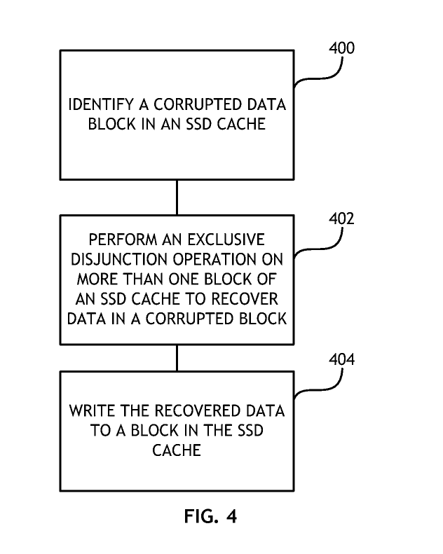

Referring to FIG. 4, another embodiment of the present invention is a method for recovering data from in an SSD cache organized with parity type redundancy. The method may include identifying 400 a corrupted logical data block in a logical stripe in an SSD cache, then performing 402 an exclusive disjunction operation on the remaining logical data blocks and a logical parity block in the logical stripe of the SSD cache. The method may include writing 404 the recovered data to a logical data block in the logical stripe of the SSD cache.

A data storage system implementing an SSD cache organized with RAID 5 parity type redundancy may increase available cache capacity for improved hit rate, and increase reliability.

It is believed that the present invention and many of its attendant advantages will be understood by the foregoing description, and it will be apparent that various changes may be made in the form, construction, and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A data storage system comprising:
a processor;
a memory connected to the processor;
a hard drive connected to the processor;
a solid state drive configured as a cache for the hard drive; and
computer readable code, stored in the memory, configured to execute on the processor,
wherein the computer readable code is configured to maintain one or more logical stripes in the solid state drive, each of the one or more logical stripes containing three or more logical blocks, wherein at least one of the logical blocks in each of the logical stripes is a logical parity block.

2. The apparatus of claim 1, wherein the computer readable code is further configured to maintain one or more logical divisions such that each logical division contains no more than one logical parity block, and each logical division contains logical data blocks from more than one logical stripe.

3. The apparatus of claim 1, wherein the computer readable code is further configured to:
write data to one or more logical data blocks in a logical stripe in the one or more logical stripes, each of the one or more logical data blocks comprising one of the three or more logical blocks;
performing an exclusive disjunction operation on one or more of the one or more logical data blocks to produce parity information; and
writing the parity information to a logical parity block associated with the logical stripe.

4. The apparatus of claim 1, wherein the computer readable code is further configured to:
receive new data to overwrite an old logical data block in a logical stripe in the one or more logical stripes;
perform an exclusive disjunction operation on the old logical data block, the new data and a logical parity block associated with the logical stripe to produce updated parity information;
write the updated parity information to the logical parity block; and
write the new data to the old logical data block.

5. The apparatus of claim 4, wherein the computer readable code is further configured to:
identify a corrupt logical block, in a logical stripe in the one or more logical stripes; and
perform an exclusive disjunction operation on one or more logical blocks in the logical stripe to re-produce data from the corrupt logical block.

6. The apparatus of claim 1, wherein the computer readable code is further configured to:
identify a corrupt logical block, in a logical stripe in the one or more logical stripes; and
perform an exclusive disjunction operation on one or more logical blocks in the logical stripe to re-produce data from the corrupt logical block.

7. The apparatus of claim 1, wherein the computer readable code is further configured to write the data from the corrupt logical block to a logical block in the logical stripe.

8. A method for maintaining data redundancy in a data storage system having an SSD cache, comprising:
writing data to one or more logical data blocks, each of the one or more logical data blocks contained in a logical stripe, in an SSD cache configured in one or more logical stripes;
performing an exclusive disjunction operation on one or more of the one or more logical data blocks to produce parity information; and
writing the parity information to a logical parity block in the logical stripe.

9. The method of claim 8, wherein the SSD cache is configured to distribute one or more logical parity blocks to separate logical divisions such that each logical parity block is associated with a distinct logical stripe and a distinct logical division and each logical division includes logical data blocks from two or more logical stripes.

10. The method of claim 8, further comprising:
receiving new data to overwrite an old logical data block in the logical stripe;
performing an exclusive disjunction operation on the old logical data block, the new data and the logical parity block to produce updated parity information;
writing the updated parity information to the logical parity block; and
writing the new data to the old logical data block.

11. The method of claim 10, wherein the SSD cache is configured to distribute one or more logical parity blocks to separate logical divisions such that each logical parity block is associated with a distinct logical stripe and a distinct logical division and each logical division includes logical data blocks from two or more logical stripes.

12. A method for recovering data in a data storage system having an SSD cache with parity type redundancy, comprising:
identifying a corrupt logical block, in a logical stripe, in an SSD cache organized into one or more logical stripes; and
performing an exclusive disjunction operation on one or more logical blocks in the logical stripe to re-produce data from the corrupt logical block.

13. The method of claim 12, wherein the SSD cache is configured to distribute one or more logical parity blocks to separate logical divisions such that each logical parity block is associated with a distinct logical stripe and a distinct logical division and each logical division includes logical data blocks from two or more logical stripes.

14. The method of claim 12, further comprising writing the data from the corrupt logical block to a logical block in the logical stripe.

15. The method of claim 12, wherein the corrupt logical block comprises a logical data block and the one or more logical blocks comprise one or more logical data blocks and a logical parity block.

16. The method of claim 15, further comprising writing the data from the corrupt logical block to a logical block in the logical stripe.

17. The method of claim 12, wherein the corrupt logical block comprises a logical parity block and the one or more logical blocks comprise one or more logical data blocks.

18. The method of claim 17, further comprising writing the data from the corrupt logical block to a logical block in the logical stripe.
